(19) United States
(12) Patent Application Publication
(10) Pub. No.: US 2009/0110167 A1
(43) Pub. Date: Apr. 30, 2009

(54) Diverting a Call Session to a Text Session

(75) Inventors: Carey B. Parker, II, Morrisville, NC (US); Sean M. Whitsell, Chapel Hill, NC (US); Michael J. Lemen, Durham, NC (US); Vijayanivas R. Raghu, Evans, GA (US); Stephen G. Newton, San Jose, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 11/924,113

(22) Filed: Oct. 25, 2007

(51) Int. Cl. H04M 3/42

(52) U.S. Cl. 379/201.02

(57) ABSTRACT

In one embodiment, a method includes receiving a call session by an end user. The method includes allowing the end user to select an option to divert the call session to a text session. The method also includes initiating a text session if the end user selects the option to divert the call session to the text session.

### TECHNICAL FIELD

The present disclosure relates generally to communication applications.

### BACKGROUND

As the communication methods available to end users increase, efficient management of utilizing these communication methods becomes even more critical. Many end users are overloaded and overwhelmed with various communication devices and applications. Thus, the ability to efficiently manage and combine these multiple communication methods presents a significant challenge to designers and end users. Unified communications enhance abilities of end users to collaborate and be more productive with other end users.

### BRIEF DESCRIPTION OF THE DRAWINGS

FIG. 1 illustrates an example system for diverting a call session to a text session;

FIG. 2 illustrates a simplified block diagram of an interface of the unified personal communicator; and

FIG. 3 illustrates an example method for diverting a call session to a text session.

### DESCRIPTION OF EXAMPLE EMBODIMENTS

Overview

In one embodiment, a method includes receiving a call session by an end user. The method includes allowing the end user to select an option to divert the call session to a text session. The method also includes initiating a text session if the end user selects the option to divert the call session to the text session.

Description

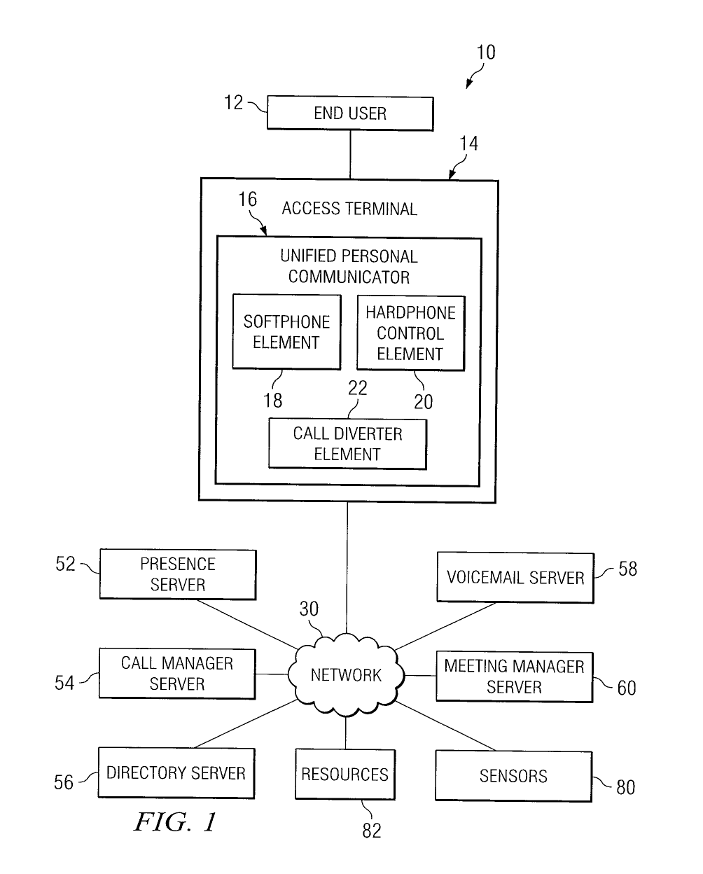

FIG. 1 is a simplified block diagram of a communication system 10 for diverting a call session to a text session. Communication system 10 includes an end user 12, an access terminal 14, a communication network 30, a presence server 52, a call manager server 54, a directory server 56, a voicemail server 58, a meeting manager server 60, sensors 80, and resources 82. Access terminal 14 may include a unified personal communicator 16. Unified personal communicator may include a softphone element 18, a hardphone control element 20, and a call diverter element 22.

In accordance with the teachings of the present disclosure, communication system 10 operates to divert a call session to a text session. A call session may include any type of communication method for speaking with other end users 12, such as an audio call or a video call. Call sessions may use session initiation protocol (SIP) signaling to communicate with a call manager server 54. A text session may include any type of communication method for communicating text data with other end users 12, such as an e-mail or instant message. Text sessions may use a protocol to communicate with a presence server 52, such that the protocol may be SIP or a proprietary protocol. For example, while end user A is logged on to unified personal communicator 16, end user B initiates a telephone call with end user A. End user A is currently not able to speak when end user B initiates a telephone call to end user A. Call diverter element 22 may generate a pop up window giving end user A several options to handle the call from end user B, such as answer the call as a conventional audio call, answer the call as a video call, divert the call to voicemail, or divert the call to instant message. End user A may use a mouse to select the option within the pop up window to divert the call to instant message. Call diverter element 22 may initiate an instant message conversation between end user A and end user B. As a result, end user A can communicate with end user B even though end user A was not available to speak with end user B on the telephone.

Important technical advantages of certain embodiments of the present disclosure include providing multiple communication methods from a single source, which allows end user to communicate faster and more effectively. Other technical advantages include advanced synergistic communication and monitoring methods by combining multiple communication and monitoring methods within a single source, which allows end user to communicate faster and more effectively. Other technical advantages of the present disclosure include monitoring the status of end points in real time, which allows end user to be more productive since end user 12 does not have to track the status of individuals or objects.

According to the illustrated embodiment, system 10 provides services such as communication sessions to end points, such as access terminal 14. A communication session refers to an active communication between end points. Information may be communicated during a communication session. Information may include voice, data, text, audio, video, multimedia, control, signaling, and/or other information. Communication sessions may be referred to as collaboration sessions. Information may be communicated in packets, each comprising a bundle of data organized in a specific way for transmission.

System 10 may utilize communication protocols and technologies to provide communication sessions. Examples of communication protocols and technologies include those set by the Institute of Electrical and Electronics Engineers, Inc. (IEEE) standards, the International Telecommunications Union (ITU-T) standards, the European Telecommunications Standards Institute (ETSI) standards, the Internet Engineering Task Force (IETF) standards (for example, mobile IP), or other standards. In some embodiments, system and unified personal communicator may utilize various protocols, such as SIP, IMAP, SOAP, HTTP, HTTPS, etcetera.

According to the illustrated embodiment, end user 12 may represent any person utilizing access terminal 14. For example, end user 12 may utilize access terminal 14 to log on to unified personal communicator 16 to communicate and collaborate with other end users 12 or to view the status of buddies on end user's unified personal communicator 16. A buddy may be any end point, such as end user 12, sensor 80, resource 82, or any other end point that is connected to the communication network that end user 12 may subscribe to via unified personal communicator 16. End user 12 may monitor the status of each buddy displayed on unified personal communicator 16. Sensors 80 and resources 82 are explained below in more detail.

According to the illustrated embodiment, access terminal 14 may represent any suitable device operable to communicate with a communication network 30. For example, end user 12 may use access terminal 14 to communicate with communication network 30. Access terminal 14 may include a personal digital assistant, a general purpose personal computer (PC), a Macintosh, a workstation, a laptop, a UNIX-based computer, a server computer, a cellular telephone, a mobile handset, and/or any other device operable to communicate with system 10. Access terminal 14 may be a mobile or fixed device.

System 10 includes a communication network 30. In general, communication network 30 may comprise at least a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication links, or any combination of any of the preceding. Communication network 30 may implement any suitable communication protocol for transmitting and receiving data or information within communication system 10.

System includes servers 52, 54, 56, 58, 60, such as presence server 52, call manager server 54, directory server 56, voicemail server 58, and meeting manager server 60. These particular servers are explained in more detail below. In one embodiment, one or more servers 52, 54, 56, 58, 60 may be physically distributed such that each server, or multiple instances of each server, may be located in a different physical location geographically remote from each other. In other embodiments, one or more servers may be combined and/or integral to each other. One or more servers may be implemented using a general-purpose personal computer (PC), a Macintosh, a workstation, a UNIX-based computer, a server computer, or any other suitable processing device. In some embodiments, servers are operable to provide security and/or authentication for end users attempting to log on to unified personal communicator 16. Servers 52, 54, 56, 58, 60 may further comprise a memory. The memory may take the form of volatile or non-volatile memory including, without limitation, magnetic media, optical media, random access memory (RAM), read-only memory (ROM), removable media, or any other suitable local or remote memory component.

Unified personal communicator 16 represents an application that includes a single interface, such that the single interface allows end users 12 access to voice, video, e-mail, instant messaging, presence data, and web conferencing. Unified personal communicator 16 represents any logic, element, or object that streamlines the communication experience of end user 12 by providing end user 12 access to voice, video, e-mail, voice mail, instant messaging, presence data, and/or web conferencing in a single interface, which allows for multimedia collaboration between two or more end users that may be located anywhere in the world. Presence data may include any type of data that indicates status of end point or data associated with end point, such as call status, user status, temperature, motion sensor data, electronic auction status, flight status, package delivery status, stock price status, etcetera. Status may be any status associated with an end point. Status may indicate available, busy, idle, on phone, away, time remaining, price, temperature, etcetera. Unified personal communicator 16 may include a SIP softphone element 18 and a hardphone control element 20. Unified personal communicator 16 may communicate with presence server 52, call manager server 54, directory server 56, voicemail server 58, and meeting manager server 60 in order to adequately provide presence data and communication methods to end user 12. Unified personal communicator 16 allows data to be exchanged between access terminal 14 and any number of selected elements within communication system 10.

Unified personal communicator 16 supports advanced communication methods for end users 12 to communicate more effectively. Traditionally, end users 12 may have used several different conventional communication devices and applications to communicate with other end users 12. Each of these conventional devices and applications may have different rules, methods, and directories. Unified personal communicator 16 simplifies the communication experience by providing the capabilities of the various conventional devices and applications into a single location, such that unified personal communicator 16 provides end user 12 with quick and easy access to a unified set of rules, methods, and directories to facilitate communication.

For example, end user 12 may search directories to locate a colleague, family member, or customer to add to end user's buddy list. Within unified presence communicator 16, end user 12 may monitor the status and availability of other end users 16 by utilizing the dynamic presence data transmitted to unified personal communicator 16. Status may be any status associated with an end point or buddy. Status may indicate available, busy, idle, on phone, away, time remaining, price, temperature, etcetera. After viewing the status of a particular buddy, end user 12 may choose a communication method from unified personal communicator 16 to communicate with other buddies based on their status.

For example, end user 12 may choose to send an instant message rather than call a particular buddy because unified personal communicator 16 indicates that this buddy is currently on the phone. Additionally, end user 12 may utilize unified personal communicator 16 to initiate a conference session, such as a video conference session, with other end users 12 that are shown as available on unified personal communicator 16. Additionally, unified personal communicator 16 allows end user 12 to select a method of communication of how end user 12 prefers to be contacted, such as voice, video, instant messaging, or e-mail. Additionally, unified personal communicator 16 allows end user 12 to view how other end users 12 prefer to be contacted. End user 12 may access a plurality of different communication methods from unified personal communicator 16 to communicate most efficiently with other end users 12. By adding and removing communication methods throughout a collaboration session as needed, unified personal communicator 16 maximizes the communication efficiency and efficacy between end users 12.

Unified personal communicator 16 supports advanced communication methods for end users 12 to reduce communication delays with other end users 12. Unified personal communicator 16 dynamically updates availability status of end users 12 in real time by displaying user status and call status for each end user 12. Unified personal communicator 16 allows end user 12 to set user status, such that other end users 12 will know when end user 12 is available.

Additionally, unified personal communicator 16 automatically updates user status based on presence events or presence data. Unified personal communicator 16 may communicate with presence server 52 to transmit user status of end user 12. Unified personal communicator 16 may also communicate with presence server 52 to receive user status updates of buddies that end user 12 has subscribed to. User status may represent end user 12 as online, offline, available, busy, away, idle, or any other useful user status. Unified personal communicator 16 automatically updates call status of end user 12 by indicating if end user 12 is currently using a voice application, such as a softphone or a hardphone. Unified personal communicator 16 may communicate with presence server 52 to receive call status of end user 12. Presence server receives data of end user call status from call manager server 54, which monitors call state of end points. Unified personal communicator 16 may also communicate with call presence server 52 to receive call status of other end users 12 that end user 12 has subscribed to. User status and call status of end users 12 are updated in real time. Knowing when other end users 12 are available helps reduce communication delays between end users 12, such that productivity of end users 12 is increased.

Unified personal communicator 16 supports advanced communication methods for end users 12 to effectively monitor status and presence data of sensors 80, resources 82, websites, other end users 12, or any end point. Unified personal communicator 16 allows end users 12 to view real time availability status and presence data of sensors 80, resources 82, websites, other end users 12, or any end point. For example, end user 12 may use unified personal communicator 16 to monitor the availability of a conference room within end user's building, the status of a package being shipped to end user, the temperature of a thermometer at a remote location, the price of an auction, or the availability of another end user 12. Sensors 80 and resources 82 are described below in more detail. Presence data associated with a sensor 80, resource 82, website, or web data may be transmitted to presence server 52. Presence server may update status of the sensor 80, resource 82, website, or web data. Alternatively, unified personal communicator 16 may update the status of the sensor 80, resource 82, website, or web data. Presence data associated with sensors 80, resources 82, websites, or web data may be received by unified personal communicator 16 from presence server 52, such that end user 12 may view user status of sensors 80, resources 82, websites, and web data in real time.

Unified personal communicator 16 allows end user 12 to customize settings to enhance communications and productivity. End users 12 may create customized messages to display to other end users 12, such as out of office alerts. End users 12 may customize various elements of the unified personal communicator 16, such as changing the colors that are associated with end user 12 being available, idle, or busy. For example, end user 12 may select green for available, yellow for idle, and red for busy. End users 12 may enable real time actions to occur based on a real time triggering event. For example, if end user 12 is subscribed to a thermometer, then end user 12 may instruct unified personal communicator 16 to send a message to end user 12 when the thermometer goes below freezing, such that message may comprise “cover up the plants because it's freezing outside!” Unified personal communicator 16 allows end user 12 to alter privacy settings, such that only certain data is displayed. End users 12 may also restrict access to other end users 12, such that only specified end users 12 may subscribe to them.

In operation of an example embodiment, end user 12 may run unified personal communicator 16 on access terminal 14. End user 12 may enter user name and password into unified personal communicator 16. Unified personal communicator 16 may register with presence server 52, call manager server 54, directory server 56, voicemail server 58, and meeting manager server 60, such that each server may verify and authenticate end user 12. End user 12 may search among one or more directory servers 56 via unified personal communicator 16 for other end users 12, resources 82, and sensors 80. Once end user 12 has found the unique ID associated with the sought after end user 12, resource 82, or sensor 80, then end user 12 may subscribe to this end point, such that end point becomes a buddy displayed on interface of unified personal communicator 16. End user 12 may utilize unified personal communicator 16 to communicate by voice, instant messaging, video, or e-mail to one or more end users 12 that this particular end user 12 has subscribed to. End user 12 may monitor the status of one or more end users 12, resources 82, or sensors 80 via unified personal communicator 16. Presence data is exchanged between unified personal communicator 16 and presence server 52. Presence data associated with end user 12 may be transmitted to presence server 52, and presence server 52 may update the user status of this particular end user 12 in real time to other end users 12 that are subscribed to this particular end user 12. Presence data associated with other end users 12 may be received by unified personal communicator 16 from presence server 52, such that end user 12 may view user status of other end users 12 in real time. Similarly, call status of end user 12 may be transmitted to call manager server 54, and call manager server 54 may send a call status update to presence server 52. Presence server 52 may merge the user status and call status to determine the availability status for a particular end user 12.

Softphone element 18 is an element that allows end user 12 to establish a call session using unified personal communicator 16 to another end user 12 via the Internet, rather than using a conventional dedicated telephone. Call session may include a telephone call or a video call. For example, end user 12 may initiate a conference call via unified personal communicator 16 by using softphone element 18.

Hardphone control element 20 is an element that allows end user 12 to control a conventional dedicated telephone by using unified personal communicator 16. For example, end user 16 may initiate a conference call via unified personal communicator 16 by using a conventional dedicated telephone.

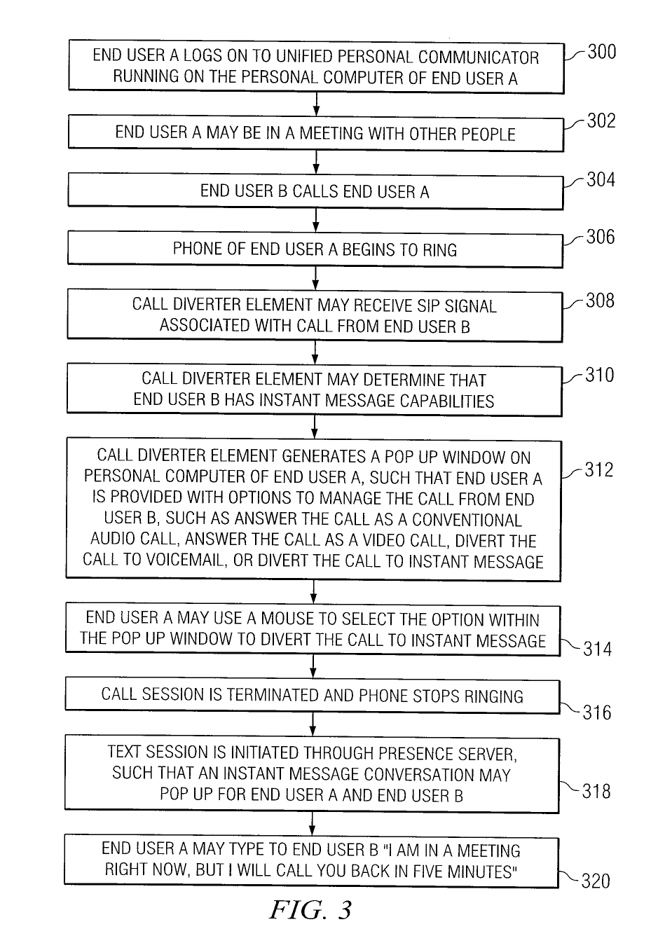

Call diverter element 22 may divert a call session to a text session. In one embodiment, call diverter element 22 is located within unified personal communicator 16. A call session may include any type of communication method for speaking with other end users 12, such as an audio call or a video call. Call sessions may use SIP signaling to communicate with a call manager server 54. A text session may include any type of communication method for communicating text data with other end users 12, such as an e-mail or instant message. Text sessions may use a protocol to communicate with a presence server 52, such that the protocol may be SIP or a proprietary protocol. For example, while end user A is logged on to unified personal communicator 16, end user B initiates a telephone call with end user A. End user A is currently not able to speak when end user B initiates a telephone call to end user A. For example, it may not be practical for end user A to take the call because end user A may be speaking on a cellular phone, talking to someone else in the office, or in a noisy environment. Call diverter element 22 may allow end user A to divert call session originating from end user B to a text session. For example, call diverter element 22 may generate a pop up window that displays several options to end user A to manage the call session from end user B, such that the options may include answering the call as a conventional audio call, answering the call as a video call, diverting the call to voicemail, or diverting the call to an instant message. End user A may use a mouse to select the option within the pop up window to divert the call session to a text session, such as an instant message conversation. Call diverter element 22 may initiate an instant message conversation between end user A and end user B. Alternatively, call diverter element 22 may communicate with presence server 52 with SIP signaling in order to initiate an instant message conversation between end user A and end user B. As a result, end user A can communicate with end user B with text data even though end user A was not available to speak with end user B on the telephone. The operations and processes associated with call diverter element 22 are described below with reference to FIG. 3.

In one embodiment, call diverter element 22 may only allow end user A to select the option of diverting call session to a text session if both end user A and end user B are logged on to respective unified personal communicators 16. Call diverter element 22 associated with end user A may determine if end user B is running unified personal communicator 16. Alternatively, call diverter element 22 may receive data from presence server 52 that indicates if end user B is running unified personal communicator 16. If end user B is not associated with a unified personal communicator 16, then call diverter element 22 may not display the option that allows end user A to divert the call session to a text session.

In one embodiment, call diverter element 22 may determine if end user B can communicate with text sessions. Alternatively, call diverter element 22 may receive data from presence server 52 that indicates if end user B can communicate with text sessions. If end user B cannot communicate with text sessions, call diverter element 22 may convert text data, such as an instant message, to audio data, such that audio data is communicated to call manager server 54 and sent to end user B. For example, end user A may type a text message reading “I will call you in five minutes.” Call diverter element 22 may convert this text data into audio data, such that end user B is able to hear an audio message stating “I will call you in five minutes.”

It is critical to note that unified personal communicator 16 and call diverter element 22 may include any suitable elements, hardware, software, objects, or components capable of effectuating their operations or additional operations where appropriate. Additionally, any one or more of the elements included in unified personal communicator 16 and call diverter element 22 may be provided in an external structure or combined into a single module or device where appropriate. Moreover, any of the functions provided by unified personal communicator 16 and call diverter element 22 may be offered in a single unit or single functionalities may be arbitrarily swapped between unified personal communicator 16 and call diverter element 22. The embodiment offered in FIG. 1 has been provided for purposes of example only. The arrangement of elements (and their associated operation(s)) may be reconfigured significantly in any other appropriate manner in accordance with the teachings of the present disclosure.

Presence server 52 is an object that may collect presence data from unified personal communicator 16 regarding status of an end point. Presence data may include any data related to status of end point, such as when end user becomes idle. Additionally, presence server 52 may collect presence data from sensors 80 and resources 82. Presence server 52 records and updates the presence status of all end points. Presence server 52 may be responsible for consolidating and disseminating the presence data of all end points. For example, when presence server 52 receives new presence data from an end point, presence server 52 sends this updated information to all end users 12 that are subscribed to that particular end point. Presence server 52 also collects data about an end user's communications capabilities, such as whether end user 12 is currently on phone or if end user 12 has certain applications enabled on access terminal 14, such as videoconferencing. Presence server 52 may also manage instant message communication between end points. In one embodiment, instant messaging between two end users 12 may utilize call signaling over SIP that is sent through presence server 52. Presence server 52 may be operable to communicate instant messages with different proprietary protocols. Presence server 52 may receive user status from unified personal communicator 16 and call status from call manager server 54. User status updates may be a result of end user 12 manually changing user status to available, busy, out of office, away, do not disturb, or a custom message. User status may also change when end user 12 logs on and off unified personal communicator 16. Call status may indicate if end user 12 is on or off a softphone or hardphone. Presence server 52 may determine availability status of end user 12 by merging the user status data and the call status data.

Presence server 52 may broadcast each end user's availability status to all other end users 12 who subscribe to that particular end user 12.

Call manager server 54 is an object that may provide call processing for calls from any end point, such as unified personal communicator 16. Call manager server 54 may manage and process various communications from and to unified personal communicator 16, such as video and/or audio calls. Call manager server 54 allows different end points to communicate with call signaling, such as SIP. Call manager server 54 may monitor call status for each end point and send the call status to presence server 52, such that presence server 52 may monitor availability of end points.

Directory server 56 is an object that may store the data for all end points in system 10. Each end point is associated with a unique identification in directory server 56. Each end point may include other data fields to describe end point, such as first name, last name, buddy name, address, floor number, conference room number, device name, telephone number, etcetera. Unified personal communicator 16 may search for an end point to subscribe for presence events by using search terms to find the proper end point listed in directory server 56. Directory server 56 entries may include end users 12, access terminals 14, resources 82, and sensors 80. Directory server 56 may include specialized databases that are optimized for a high amount of writes, updates, queries, and searches.

Voicemail server 58 is an object that consolidates voicemails, such that end users 12 may access voicemail through unified personal communicator 16. For example, unified personal communicator 16 may display a list of voicemails associated with a name of who left the voicemail. End user 12 may select to listen to any voicemail from the list of voicemails.

Meeting manager server 60 is an object that may provide voice, video, and web conferencing capabilities to unified personal communicator 16. Unified personal communicator 16 may utilize meeting manager server 60 to allow end user 12 to participate in an audio conference call, video conference call, or a web collaboration conference call, such that end user 12 may whiteboard and share files.

Sensors 80 are any objects that may monitor and record presence data or any other data. Sensors 80 may include thermometers, thermostats, motion sensors, central processor unit sensors, light switches, microphones, etcetera. Sensors 80 may be registered on directory server 56, such that end users 12 may search and subscribe to sensors 80. Sensor 80 may register on directory server 56 when sensor 80 is connected to network 30. Sensors 80 may transmit data to presence server 52 or end points. Sensors 80 may receive one or more commands originating from unified personal communicator 16. Sensors 80 may process the one or more commands. For example, unified personal server 16 may command a central processor unit to restart or command a thermostat to turn on air conditioning. Unified personal communicator 16 may communicate with presence server 52 to receive current presence data and real time updates of presence data associated with sensors 80. Sensors 80 may communicate with unified personal communicator 16 in addition to sending presence data. One or more sensors 80 may be associated with resource 82, such that sensors 80 may provide presence data associated with resource 82.

Resources 82 are any objects that may be finite in number that are utilized or reserved by end users 12. Resources 82 may be included in an inventory system. Resources 82 are any objects that end user 12 may want to reserve when unavailable. Additionally, resources 82 are any objects that end user 12 may want to know the status of before end user 12 attempts to access resource 82. Resources 82 may be monitored with presence data. Resources 82 may include any object with a finite number available for end users 12 to utilize, such as equipment, conference rooms, library books, etcetera. Resources 82 may be registered on directory server 56, such that end users 12 may subscribe to resources 82. End users 12 subscribed to resources 82 may be notified when presence data associated with resources 82 is updated. Resource 82 may or may not be connected to network 30, but methods are readily available to communicate presence data and/or resource state to presence server 52. For example, a library book may not be connected to network 30, but a librarian may use a scanning device to scan bar code associated with library book, such that the scanned data or book status is sent to presence server 52. Additionally, an inventory system may track the status of library book and send presence data or status associated with library book to presence server 52. One or more sensors 80 may be associated with a particular resource 82, such that presence server 52 may monitor the status of resource 82. For example, a conference room may include a light sensor, a microphone sensor, and a motion sensor, such that each of these sensors 82 are sending presence data to presence server 52 in real time.

In one embodiment, presence server 52 may merge the presence data associated with sensors 80, resources 82, websites, or web data. For example, presence server 52 may merge the presence data from a light switch, microphone, and motion sensor to determine the resource status of a conference room associated with these sensors. Alternatively, a separate server or unified personal communicator 16 may merge the presence data associated with sensors 80, resources 82, websites, or web data. Resource status may include additional information, such as the time and date resource 82 will be available for end user 12.

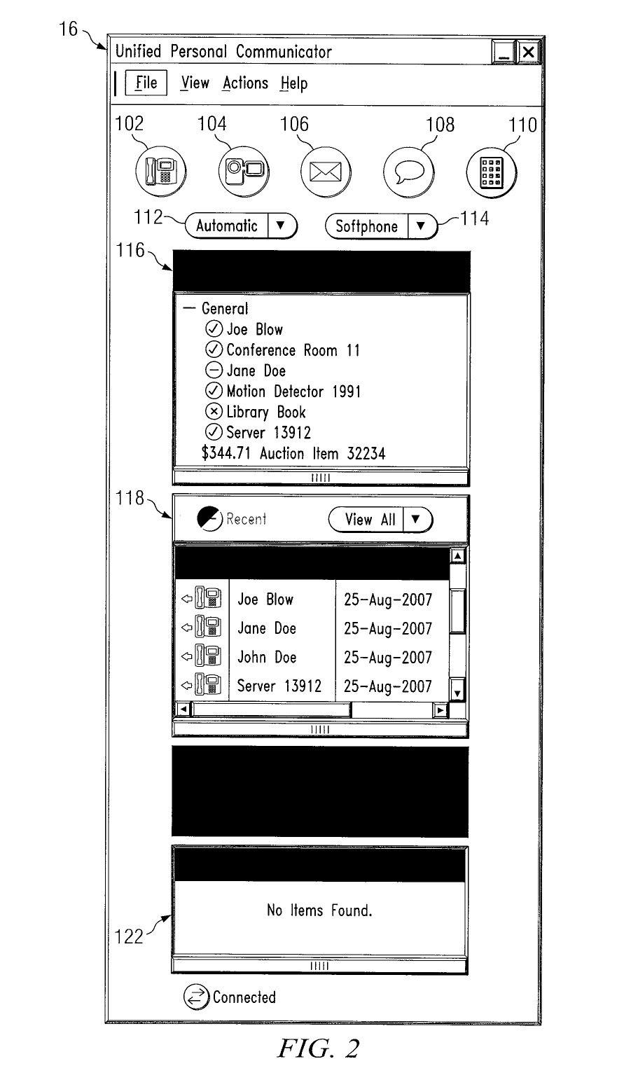

FIG. 2 is a simplified block diagram of an interface of unified personal communicator 16 in accordance with one embodiment of the present disclosure. This embodiment of interface displays a pull down menu for file, view, actions, and help. Interface allows end user to choose from several communication methods, including voice 102, video 104, e-mail 106, instant message 108, or dial pad 110. A user status pull down menu 112 allows end user 12 to manually select a user status or allow unified personal communicator 16 to automatically monitor user status. A communication preference pull down menu 114 allows end user to select the preferred method of communicating with other end users. Contacts 116 may be grouped into lists, such that lists contain buddies associated with that particular list. Buddies may include end points, such as other end users, resources, or sensors. Interface of unified personal communicator 16 may also display recent communication sessions 118 with buddies, such that details of communication sessions are displayed. Communication sessions may include voice, video, e-mail, or instant message. Search field 120 allows end user to search directory server 56 to locate buddies to subscribe to. Search field results 122 display any buddies that were located as a result of the search.

FIG. 3 is a simplified flowchart illustrating an example method for diverting a call session to a text session. The flowchart may begin at step 300 when end user A logs on to unified personal communicator 16 running on the personal computer of end user A. At step 302, end user A may be in a meeting with other people.

At step 304, end user B calls end user A. At step 306, phone of end user A begins to ring. At step 308, call diverter element may receive SIP signal associated with call from end user B. At step 310, call diverter element may determine that end user B has instant message capabilities.

At step 312, call diverter element 22 generates a pop up window on personal computer of end user A, such that end user A is provided with options to manage the call from end user B, such as answer the call as a conventional audio call, answer the call as a video call, divert the call to voicemail, or divert the call to instant message.

At step 314, end user A may use a mouse to select the option within the pop up window to divert the call to instant message. At step 316, call session is terminated and phone stops ringing.

At step 318, text session is initiated through presence server 52, such that an instant message conversation may pop up for end user A and end user B. At step 320, end user A may type to end user B “I am in a meeting right now, but I will call you back in five minutes.”

Some of the steps illustrated in FIG. 3 may be changed or deleted where appropriate and additional steps may also be added to the flowcharts. These changes may be based on specific communication architectures or particular interfacing arrangements and configurations of associated elements and do not depart from the scope or the teachings of the present disclosure. The interactions and operations of the elements within unified personal communicator 16 and call diverter element 22, as disclosed in FIG. 3, have provided merely one example for their potential applications. Numerous other applications may be equally beneficial and selected based on particular networking needs.

Although the present disclosure has been described in detail with reference to particular embodiments, communication system 10 may be extended to any scenario in which end user 12 is utilizing unified personal communicator 16 to monitor the status and/or communicate with end points. Additionally, although communication system 10 has been described with reference to a number of elements included within unified personal communicator 16, these elements may be rearranged or positioned anywhere within communication system 10. In addition, these elements may be provided as separate external components to communication system 10 where appropriate. The present disclosure contemplates great flexibility in the arrangement of these elements as well as their internal components. For example, in an alternative embodiment interface for unified personal communicator 16 may include different elements or the same elements arranged differently. Moreover, although FIGS. 1 and 2 illustrate an arrangement of selected elements, numerous other components may be used in combination with these elements or substituted for these elements without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An apparatus, comprising:
a unified personal communicator utilized by an end user; and
a call diverter element operable to:
receive a call session;
allow the end user to select an option to divert the call session to a text session; and
initiate a text session if the end user selects the option to divert the call session to the text session.

2. The apparatus of claim 1, wherein the call diverter element is further operable to:
determine if a second end user can process the text session, wherein the second end user initiates the call session; and
convert text data sent from the end user to audio data if the second user cannot process the text session.

3. The apparatus of claim 2, wherein the call diverter element is further operable to send audio data to the second end user.

4. The apparatus of claim 1, wherein the call diverter element is further operable to terminate the call session when the end user selects the option to divert the call session to the text session.

5. The apparatus of claim 1, wherein the call diverter element is further operable to send an instant message to a second end user, wherein the second end user initiates the call session.

6. The apparatus of claim 1, wherein the call diverter element is further operable to:
generate a pop up window; and
receive input from the end user, wherein the input is associated with the option selected by the end user.

7. The apparatus of claim 1, wherein the text session is an instant message session.

8. The apparatus of claim 1, wherein the call diverter element is further operable to receive an instant message from a second end user, wherein the second end user initiates the call session.

9. The apparatus of claim 1, wherein the text session is communicated by session initiation protocol (SIP) signaling.

10. A method, comprising
receiving a call session by an end user;
allowing the end user to select an option to divert the call session to a text session; and
initiating a text session if the end user selects the option to divert the call session to the text session.

11. The method of claim 10, further comprising:
determining if a second end user can process the text session, wherein the second end user initiates the call session; and
converting text data sent from the end user to audio data if the second user cannot process the text session.

12. The method of claim 11, further comprising sending audio data to the second end user.

13. The method of claim 10, further comprising terminating the call session when the end user selects the option to divert the call session to the text session.

14. The method of claim 10, further comprising sending an instant message to a second end user, wherein the second end user initiates the call session.

15. The method of claim 10, further comprising:
generating a pop up window; and
receiving input from the end user, wherein the input is associated with the option selected by the end user.

16. The method of claim 10, wherein the text session is an instant message session.

17. The method of claim 10, further comprising receiving an instant message from a second end user, wherein the second end user initiates the call session.

18. The method of claim 10, wherein the wherein the text session is communicated by SIP signaling.

19. Logic encoded in one or more tangible media for execution and when executed operable to:
receive a call session;
allow the end user to select an option to divert the call session to a text session; and
initiate a text session if the end user selects the option to divert the call session to the text session.

20. The logic of claim 19, further operable to:
determine if a second end user can process the text session, wherein the second end user initiates the call session; and
convert text data sent from the end user to audio data if the second user cannot process the text session.
